(19) United States
(12) Patent Application Publication
(10) Pub. No.: US 2015/0253730 A1
(43) Pub. Date: Sep. 10, 2015

(54) METHOD AND APPARATUS FOR GENERATING/CONVERTING DIGITAL HOLOGRAM

(71) Applicant: Korea Electronics Technology Institute, Seongnam-si (KR)

(72) Inventors: Choong Sang CHO, Seongnam-si (KR); Byeong Ho CHOI, Yongin-si (KR)

(73) Assignee: Korea Electronics Technology Institute, Seongnam-si (KR)

(21) Appl. No.: 14/582,354

(22) Filed: Dec. 24, 2014

(30) Foreign Application Priority Data
Mar. 4, 2014 (KR) 10-2014-0025430
Nov. 14, 2014 (KR) 10-2014-0158541

(51) Int. Cl. G03H 1/08

(52) U.S. Cl. CPC G03H 1/0866; G03H 1/0808; G03H 1/0891

(57) ABSTRACT

A method and apparatus for generating/converting a digital hologram is provided. The method for generating the digital hologram includes: clustering points of a 3D object to a plurality of clusters according to a distance to a screen; generating diffraction patterns in a unit of a cluster; and generating a fringe pattern by overlapping the diffraction patterns with one another. Accordingly, calculation complexity can be reduced and thus it is possible to generate a digital hologram at high speed. Since a range/size of a cluster which has a trade-off relationship with an image quality of a digital hologram is adjustable, it is possible to generate a customized flexible digital hologram.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on Mar. 4, 2014, and assigned Serial No. 10-2014-0025430, and a Korean patent application filed on Nov. 14, 2014 and assigned Serial No. 10-2014-0158541, the entire disclosure of which is hereby incorporated by reference.

### TECHNICAL FIELD OF THE INVENTION

The present invention relates generally to graphic and 3-dimensional (3D) technology, and more particularly, to a method and apparatus for generating a digital hologram.

### BACKGROUND OF THE INVENTION

In recent years, interest in digital holography is growing now that the digital holography can provide 3D information having an enhanced sense of reality for a real 3D object.

In a digital hologram, 3D information of an object is recorded on a holographic fringe pattern. The holographic fringe pattern is acquired by an interference pattern between a 3D object and a reference wave or a numeral diffraction equation.

The most representative method for generating a digital hologram by the numerical diffraction equation is a method using a Rayleigh-Sommerfeld (RS) diffraction equation. The RS technique assumes that a diffraction screen is placed on a plane of Z=0, and generates a holographic fringe pattern by generating diffraction patterns for all points of the 3D object according to Equation 1 presented below and overlapping the diffraction patterns with one another:

$$Γ ( ξ , η ) = - \frac{i}{λ} {\int }_{- ∞}^{∞} {\int }_{- ∞}^{∞} {\int }_{- ∞}^{∞} A ( x , y , z ) \frac{exp ( i k ρ )}{ρ} cos [ χ ( x , y , z ) ] d x d y d z \\ ρ = \sqrt{{( ξ - x )}^{2} + {( η - y )}^{2} + {( d - z )}^{2}} \qquad Equation 1$$

where k=2π/λ, and (ξ,η) and (x,y,z) are coordinates of a holographic fringe pattern and a 3D object, respectively. d is a focal distance of a generated digital hologram and λ is a wavelength. A(X,Y,Z) and χ(X,Y,Z) are a point amplitude and a diffraction angle at (X,Y,Z), respectively. ρ is a distance between a 3D object point and a fringe pattern point.

The RS technique should generate diffraction patterns for all of the points of the 3D object by using Equation 1 and overlap the diffraction patterns with one another in order to generate a digital hologram.

FIG. 1 shows a result of overlapping the plurality of diffraction patterns with one another. The result of the overlapping of the diffraction patterns for all points is a holographic fringe pattern.

As can be seen from Equation 1, calculation required to generate the diffraction patterns in the RS technique is complicated and the diffraction patterns should be generated for all of the points constituting the 3D object. Therefore, there is a problem that the total quantity of calculation increases.

In addition, it is common that the holographic fringe pattern is generated from 3D data. To generate a hologram from a 2D image, a Fourier hologram generation method is used. However, this method may not provide a great sense of reality.

### SUMMARY OF THE INVENTION

To address the above-discussed deficiencies of the prior art, it is a primary aspect of the present invention to provide a method and apparatus for generating a digital hologram at high speed by reducing a quantity of calculation required to generate the digital hologram.

Another aspect of the present invention is to provide a method and system for converting a 2D image into a hologram of a great sense of reality.

According to one aspect of the present invention, a method for generating a digital hologram includes: clustering points of a 3D object to a plurality of clusters according to a distance to a screen; generating diffraction patterns in a unit of a cluster; and generating a fringe pattern by overlapping the diffraction patterns with one another.

A distance range of points comprised in a same cluster to the screen may be adjustable.

The distance range may be determined on the basis of calculation complexity.

The generating the diffraction patterns may include generating the diffraction patterns simultaneously by calculating in parallel for the respective clusters.

The generating the diffraction patterns may include generating the diffraction patterns using an RS diffraction equation which is approximated through Taylor series approximation.

The approximation may be approximating a distance between an 3D object point and a fringe pattern point using a first term of Taylor series expansion in the RS diffraction equation.

A focal distance of a digital hologram in the RS diffraction equation may be adjusted by a symmetric kernel function regarding the distance to the screen.

According to another aspect of the present invention, an apparatus for generating a digital hologram includes: a clustering unit configured to cluster points of a 3D object to a plurality of clusters according to a distance to a screen; a diffraction pattern generation unit configured to generate diffraction patterns in a unit of a cluster; and a fringe pattern generation unit configured to generate a fringe pattern by overlapping the diffraction patterns with one another.

A distance range of points comprised in a same cluster to the screen may be adjustable.

The distance range may be determined on the basis of calculation complexity.

The diffraction pattern generation unit may be configured to generate the diffraction patterns simultaneously by calculating in parallel for the respective clusters.

The diffraction pattern generation unit may be configured to generate the diffraction patterns using an RS diffraction equation which is approximated through Taylor series approximation.

The approximation may be approximating a distance between an 3D object point and a fringe pattern point using a first term of Taylor series expansion in the RS diffraction equation.

A focal distance of a digital hologram in the RS diffraction equation may be adjusted by a symmetric kernel function regarding the distance to the screen.

According to another aspect of the present invention, a computer-readable recording medium records thereon a program performing a method for generating a digital hologram, including: clustering points of a 3D object to a plurality of clusters according to a distance to a screen; generating diffraction patterns in a unit of a cluster; and generating a fringe pattern by overlapping the diffraction patterns with one another.

According to another aspect of the present invention, a method for converting into a hologram includes: a first generation step for generating a hologram fringe pattern from an image; and a second generation step for generating a hologram by reconstructing the hologram fringe pattern.

The first generation step may include a step for generating the hologram fringe pattern using one of a first technique for generating a hologram fringe pattern including real data from the image, and a second technique for generating a hologram fringe pattern including complex data from the image.

The first generation step may selectively use one of the first technique and the second technique on the basis of an attribute of the image.

In addition, the first technique may be based on a Rayleigh-Sommerfelds Approximation-based algorithm, and the second technique may be based on a Fresnel Approximation-based algorithm.

The second technique may inversely use a Fresnel Approximation Reconstruction (FAR)-based hologram reconstructing algorithm.

According to another aspect of the present invention, a hologram conversion system includes an image-hologram conversion unit configured to generate a hologram fringe pattern from an image; and a reconstructing unit configured to generate a hologram by reconstructing the hologram fringe pattern.

According to exemplary embodiments of the present invention as described above, since points of a 3D object are clustered and diffraction patterns are generated in the unit of a cluster, calculation complexity can be reduced and thus it is possible to generate a digital hologram at high speed.

In addition, since a range/size of a cluster which has a trade-off relationship with an image quality of a digital hologram is adjustable, it is possible to generate a customized flexible digital hologram.

In addition, according to exemplary embodiments of the present invention, a 2D image can be converted into a hologram of a high sense of reality. In particular, since various techniques for generating a hologram from a 2D image can be adaptively used, it is possible to generate an optimal hologram from the 2D image.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view showing an example of diffraction patterns and a holographic fringe which are generated in a related-art RS technique;

FIG. 2 is a view showing a result of point clustering in a z direction;

FIG. 3 is a block diagram of a hologram generation apparatus according to another exemplary embodiment of the present invention;

FIGS. 4 to 6 are views to explain a result of evaluating performance of a hologram generation method according to exemplary embodiments of the present invention;

FIG. 7 is a view to explain an image-hologram conversion system according to an exemplary embodiment of the present invention;

FIG. 8 is a view to explain a conversion process by an image-hologram conversion unit;

FIG. 9 is a view showing a result of generating a hologram fringe pattern including real data using a Fast Rayleigh-Sommerfelds Approximation (FRSA) technique;

FIG. 10 is a view showing a result of generating a hologram fringe pattern including complex data using an Inverse Fresnel Approximation Reconstruction (IFAR) technique;

FIG. 11 is a view showing a result of recovering a hologram fringe pattern using the FRSA technique; and

FIG. 12 is a view showing a result of recovering a hologram fringe pattern using the IFRA technique.

### DETAILED DESCRIPTION OF THE INVENTION

Reference will now be made in detail to the embodiment of the present general inventive concept, examples of which are illustrated in the accompanying drawings, wherein like reference numerals refer to the like elements throughout. The embodiment is described below in order to explain the present general inventive concept by referring to the drawings.

Exemplary embodiments of the present invention propose a high-speed flexible digital hologram generation method through point clustering in a z direction and a Fast Fourier Transform (FFT)-based equation change by Talyor series approximation.

To simplify Equation 1, it is assumed that a diffraction angle at a point is 0 and ρ≈d is used. Then, Equation 1 may be approximated to Equation 2 presented below:

$$Γ ( ξ , η ) = \frac{- i}{λ d} {\int }_{- ∞}^{∞} {\int }_{- ∞}^{∞} {\int }_{- ∞}^{∞} A ( x , y , z ) exp ( i \frac{2 π}{λ} ρ ) d x d y d z \qquad Equation 2$$

where ρ may be expressed by Equation 3 presented below:

$$\begin{matrix}ρ = \sqrt{{( ξ - x )}^{2} + {( η - y )}^{2} + {( d - z )}^{2}} \\ = \sqrt{{d}^{2} [ 1 + \frac{{( x - ξ )}^{2} + {( y - η )}^{2} + {z}^{2} - 2 dz}{{d}^{2}} ]} \\ = d \sqrt{1 + \frac{{( x - ξ )}^{2} + {( y - η )}^{2} + {z}^{2} - 2 dz}{{d}^{2}}}\end{matrix} \qquad Equation 3$$

where it is assumed that a diffraction angle is 0 for mathematical equation expansion. However, Equation 2 may be expanded as shown in Equation 2-1 without assuming that the diffraction angle is 0:

$$Γ ( ξ , η ) = - \frac{i}{λ d} {\int }_{- ∞}^{∞} {\int }_{- ∞}^{∞} {\int }_{- ∞}^{∞} {A}^{′} ( x , y , z ) exp ( i k ρ ) d x d y d z , {A}^{′} ( x , y , z ) ≡ A ( x , y , z ) \times cos [ χ ( x , y , z ) ] \qquad Equation 2 \text{-} 1$$

The distance is approximated by changing ρ to ρ′ using the first term of the Tayler series expansion as shown in Equation 4:

$$\begin{matrix}ρ = d \{ 1 + \frac{1}{2} [ \frac{{( x - ɛ )}^{2} + {( y - η )}^{2} + {z}^{2} - 2 dz}{{d}^{2}} ] \} \\ = d + \frac{1}{2} [ \frac{{( x - ɛ )}^{2} + {( y - η )}^{2} + {z}^{2} - 2 dz}{d} ]\end{matrix} \qquad Equation 4$$

Since a difference between focused points and unfocused points depends on the distance, the difference is reduced by approximating the distance. That is, the range of the difference between the focused point and the unfocused point is reduced by approximating the distance and the degree of focusing is similar for many points of the 3D object. To compensate for the reduction in the difference between the focused point and the unfocused point, the focal distance d is adjusted by a symmetric kernel function for a z location as shown in Equation 5 presented below:

$${d}^{′} = d \times f ( ξ , η ) , \\ f ( ξ , η ) = 1 + sign [ {z}_{p} ( ξ , η ) ] \times K \frac{exp ( \frac{1}{N \text{/} 2} {z}_{p} ( ξ , η ) ) - 1}{exp ( 1 ) - 1} , \\ {z}_{p} ( ξ , η ) = z \times N \text{/} 2 \qquad Equation 5$$

where K is a weight, N is a z direction dimension of points, and a range of a normalized z is [−1;1].

When an approximated distance ρ′ and an adjusted focal length d′ are applied, the numerical digital hologram diffraction equation may be expressed by Equation 6 presented below:

$${Γ}^{′} ( ξ , η ) = \frac{- i}{λ d} {\int }_{- ∞}^{∞} {\int }_{- ∞}^{∞} {\int }_{- ∞}^{∞} A ( x , y , z ) exp ( i \frac{2 π}{λ} \{ {d}^{′} + \frac{1}{2} [ \frac{{( x - ξ )}^{2} + {( y - η )}^{2} + {z}^{2} - 2 {zd}^{′}}{{d}^{′}} ] \} ) \qquad Equation 6$$

To derive mathematical similarity to the Fourier transform, Equation 6 may be expressed by Equation 7 presented below:

$${Γ}^{′} ( ξ , η ) = {\int }_{- ∞}^{∞} {\int }_{- ∞}^{∞} {\int }_{- ∞}^{∞} W ( ξ , η ) P ( x , y , z ) exp \{ - i \frac{π}{λ {d}^{′}} [ 2 ( x ξ + y η ) ] \} d x d y d z \\ W ( ξ , η ) ≡ \frac{- i}{λ d} exp ( i \frac{2 π}{λ} {d}^{′} ) exp [ i \frac{π}{λ {d}^{′}} ( {ξ}^{2} + {η}^{2} ) ] \\ P ( x , y , z ) ≡ A ( x , y , z ) exp \{ i \frac{π}{λ d} [ ( {x}^{2} + {y}^{2} + {z}^{2} - 2 {zd}^{′} ) ] \} \qquad Equation 7$$

where two variables ν and μ are expressed by Equation 8 presented below:

$$v = \frac{ξ}{λ {d}^{′}} and μ = \frac{η}{λ {d}^{′}} \qquad Equation 8$$

When ν and μ in Equation 7 are substituted with those of Equation 8, the approximated numerical digital hologram diffraction equation may be expressed in the form of an FFT as shown in Equation 9 presented below:

$$Γ ( ξ , η ) \approx {Γ}^{′} ( ξ , η ) = {\int }_{- ∞}^{∞} W ( ξ , η ) FFT \{ A ( x , y , z ) exp [ i \frac{π}{λ {d}^{′}} ( {x}^{2} + {y}^{2} + {z}^{′} - 2 {d}^{′} z ) ] \} d z \qquad Equation 9$$

To convert the continuous form of Equation 9 into a discrete form, coordinates of the fringe pattern and the 3D object may be converted into discrete expressions as follows:

$$ξ = m Δ v , η = n Δ μ , x = k Δ x , y = l Δ y , z = j Δ z \\ Δ v = \frac{1}{N Δ x} , Δ μ = \frac{1}{M Δ y} , Δ ξ = \frac{λ {d}^{′}}{N Δ x} , Δ η = \frac{λ {d}^{′}}{M Δ y} \qquad Equation 10$$

where N and M are the number of discrete points of x and the number of discrete points of y in the fringe pattern, respectively, and ΔX, ΔY, and ΔZ are a discrete step of x, a discrete step of y, and a y direction of a 3D object location.

When the coordinates of Equation 9 are substituted with those of Equation 10, a discrete equation for approximated high speed generation may be obtained as shown in Equation 11 presented below:

$${Γ}_{d}^{′} ( m , n ) = {\sum }_{j = 0}^{J - 1} ( W ( m , n ) FFT \{ A ( k , l , j ) exp [ i \frac{π}{λ {d}^{′}} ( {k}^{2} Δ {x}^{2} + {l}^{2} Δ {y}^{2} + {j}^{2} Δ {z}^{2} - 2 {d}^{′} j Δ z ) ] \} ) \qquad Equation 11$$

where J is the number of clusters generated by Δz. According to Equation 11, points having the same discrete z location (that is, points included in the same cluster) are calculated by the FFT and are weighted by W(m,n).

Results regarding different discrete Z locations are independently calculated and overlapped. In approximated discrete generation, complexity of generation is determined by the number of grouped z locations (clusters), and is flexibly adjusted by a quantization step size Δz in the z direction.

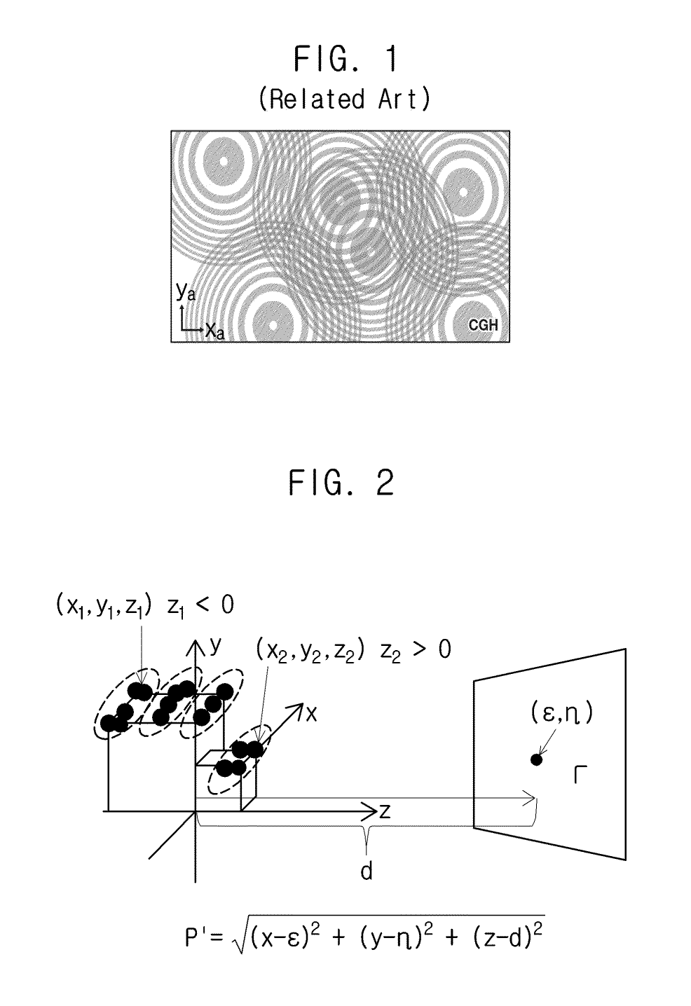

FIG. 2 illustrates a result of clustering points of a 3D object to four clusters (indicated by dashed lines) according to a z location (a distance to a screen). Since diffraction patterns are generated in the unit of the illustrated cluster, diffraction patterns for the 4 groups are generated when the pointers are clustered as shown in FIG. 2.

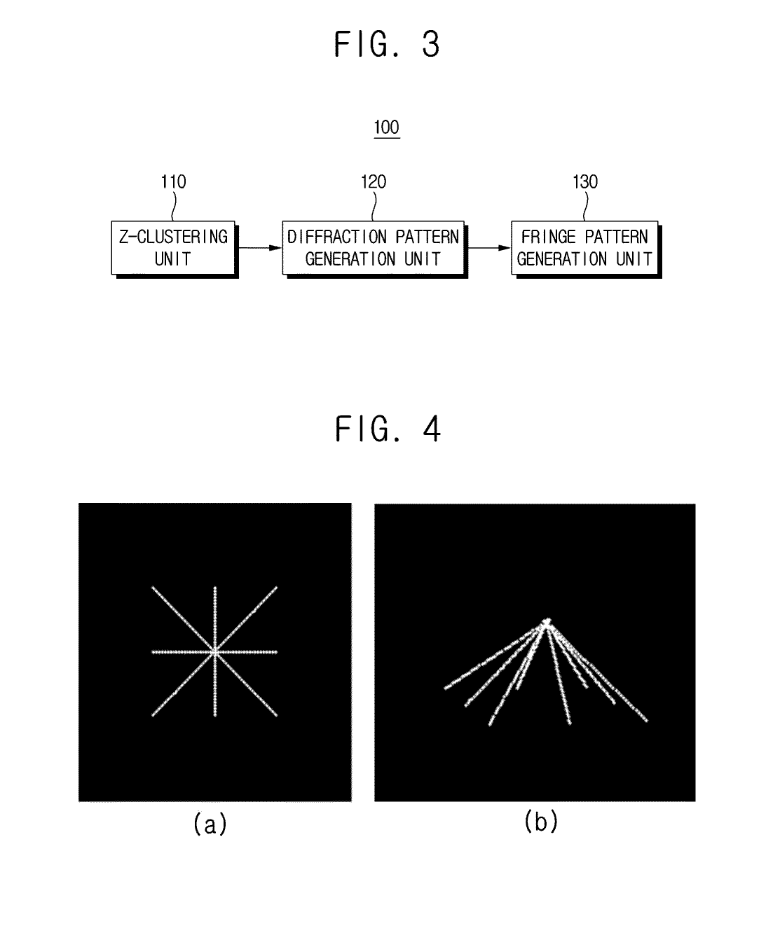

FIG. 3 is a block diagram of a hologram generation apparatus according to another exemplary embodiment of the present invention. As shown in FIG. 3, the hologram generation apparatus 100 according to an exemplary embodiment of the present invention includes a z-clustering unit 110, a diffraction pattern generation unit 120, and a fringe pattern generation unit 130.

The z-clustering unit 110 clusters points of a 3D object according to a z location (a distance to a screen). The points of the 3D object belong to one of a plurality of clusters by the z-clustering unit 110.

As described above, complexity of generation is flexibly adjusted by the quantization step size Δz in the z direction which indicates a distance range of the points included in the same cluster to the screen, and Δz may be determined on the basis of calculation complexity.

The diffraction pattern generation unit 120 generates diffraction patterns. Specifically, the diffraction pattern generation unit 120 generates the diffraction patterns in the unit of cluster generated by the z-clustering unit 110.

Since the diffraction patterns are generated in the unit of cluster, the diffraction pattern generation unit 120 may generate the diffraction patterns simultaneously by calculating in parallel for the respective clusters.

The diffraction pattern generation unit 120 generates the diffraction patterns using the RS diffraction equation which is approximated by the Taylor series approximation. The approximation recited herein refers to approximating a distance of a 3D object point and a fringe pattern point using the first term of the Taylor series expansion in the RS diffraction equation.

In addition, to compensate for the approximation of the distance, the diffraction pattern generation unit 120 adjusts a focal distance of a digital hologram according to a symmetric kernel function regarding the distance.

The fringe pattern generation unit 130 generates a fringe pattern by overlapping the diffraction patterns generated by the diffraction pattern generation unit 120.

Up to now, a high-speed flexible digital hologram generation method and apparatus according to preferred embodiments has been described.

To evaluate performance, the hologram generation method according to the exemplary embodiment of the present invention and a related-art method are compared. Views (a) and (b) of FIG. 4 illustrate a front view and a side view of points of a 3D object to be used for generating a fringe pattern for evaluating performance.

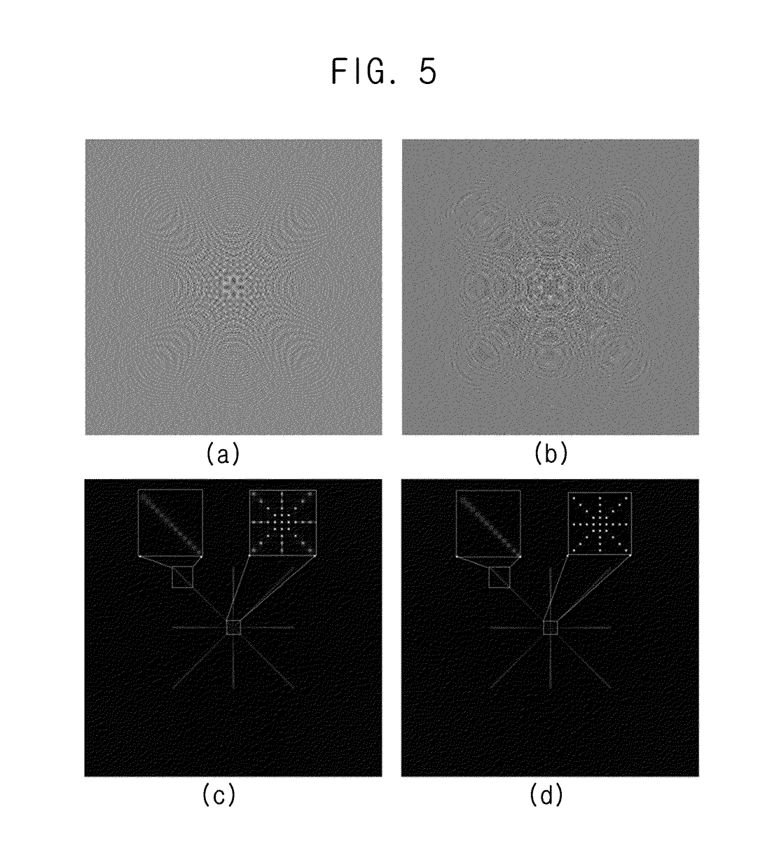

Views (a) and (c) of FIG. 5 illustrate a fringe pattern which is generated in the RS technique and a result of reconstructing thereof, and views (b) and (d) of FIG. 5 illustrate a fringe pattern which is generated according to the exemplary embodiment of the present invention and a result of reconstructing thereof. In views (c) and (d) of FIG. 5, a part of the fringe pattern is enlarged.

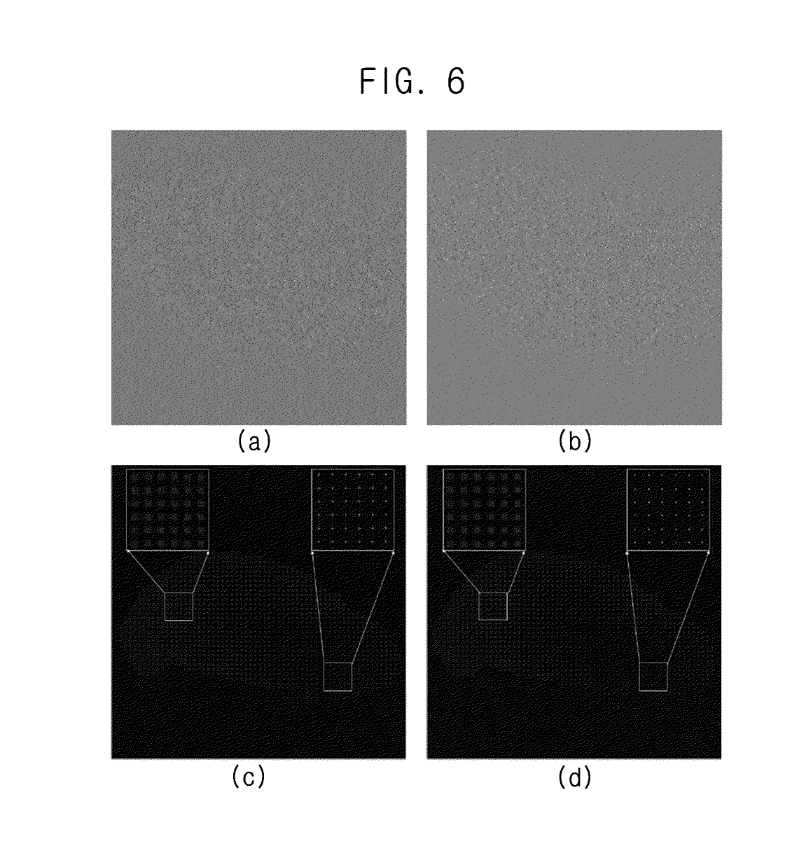

Compared with the related-art method, the method according to the exemplary embodiment of the present invention can provide an image quality similar to that of the related-art method even with low calculation complexity. FIG. 6 illustrates performance comparison by other sources and it can be seen that the same conclusion can be obtained.

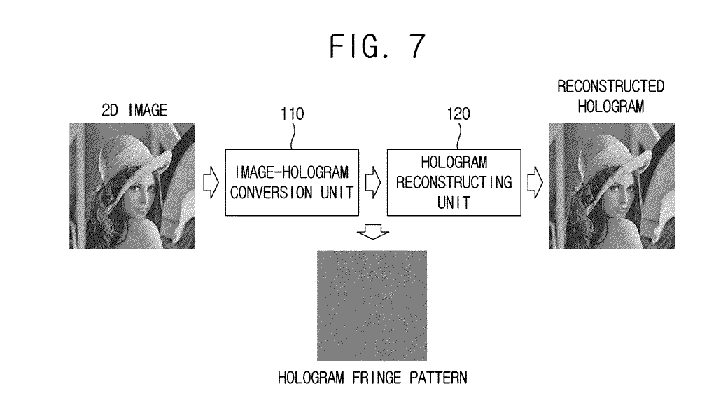

FIG. 7 is a view to explain an image-hologram conversion system according to an exemplary embodiment of the present invention. The image-hologram conversion system according to an exemplary embodiment of the present invention is a system for reconstructing a 2D image to a hologram.

The image-hologram conversion system performing such a function includes an image-hologram conversion unit 210 and a hologram reconstructing unit 220 as shown in FIG. 7.

The image-hologram conversion unit 210 generates a hologram fringe pattern from a 2D image, and transmits the generated hologram fringe pattern to the hologram reconstructing unit 220.

The hologram reconstructing unit 220 generates a hologram by reconstructing the hologram fringe pattern received from the image-hologram conversion unit 210.

FIG. 7 illustrates a 2D image on the left view and a reconstructed hologram on the right view. Although the both images look alike due to the limitation of drawing, the both images show different display aspects in reality.

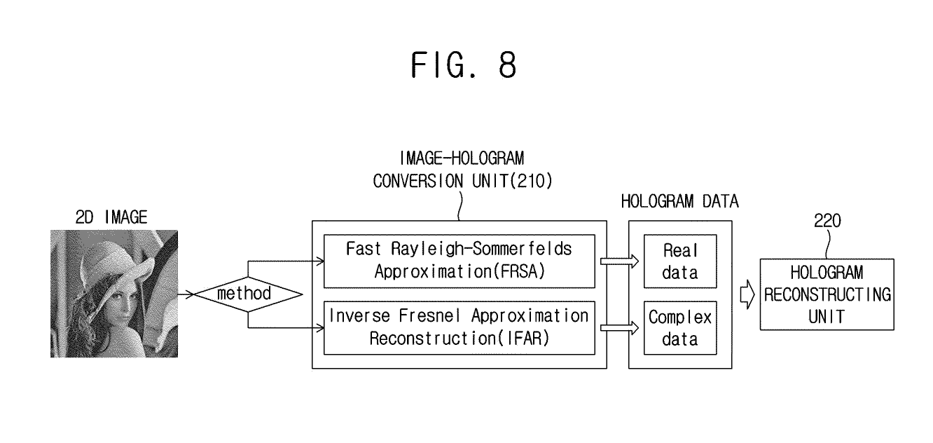

The image-hologram conversion unit 210 generates the hologram fringe pattern from the 2D image in two techniques. Hereinafter, the two techniques will be explained with reference to FIG. 8. FIG. 8 is a view to explain a method for converting by the image-hologram conversion unit 210 in detail.

As shown in FIG. 8, the image-hologram conversion unit 210 generates the hologram fringe pattern from the 2D image in two techniques. One technique is a Fast Rayleigh-Sommerfelds Approximation (FRSA) and the other technique is Inverse Fresnel Approximation Reconstruction (IFAR).

The image-hologram conversion unit 210 generates the hologram fringe pattern from the 2D image selectively using one of the FRSA and the IFAR. The used technique may be divided into a manual method which is set by the user and an automatic method which sets an optimal technique according to an attribute of the 2D image.

The FRSA technique uses a structure in which Rayleight-Sommerfeld is approximated on the basis of FFT. This technique uses an RS diffraction equation as a numerical diffraction equation indicating a holographic fringe pattern on which image information is recorded in a digital hologram.

The FRSA technique generates the holographic fringe pattern by generating diffraction patterns for all points of the image according to Equation 12 presented below and overlapping the diffraction patterns with one another:

$$Γ ( m , n ) = - \frac{i}{λ} {\int }_{- ∞}^{∞} {\int }_{- ∞}^{∞} A ( x , y ) \frac{exp ( i kd )}{d} cos [ X ( x , y ) ] d x d y \\ d = \sqrt{{( m - x )}^{2} + {( n - y )}^{2}} \qquad Equation 12$$

where k=2π/λ, (m,n) and (x,y) are coordinates of a holographic fringe pattern and an image, respectively, and λ is a wavelength. A(x,y) and χ(x,y) are a point amplitude and a diffraction angle at (x,y), respectively, and d is a distance between an image point and a fringe pattern point.

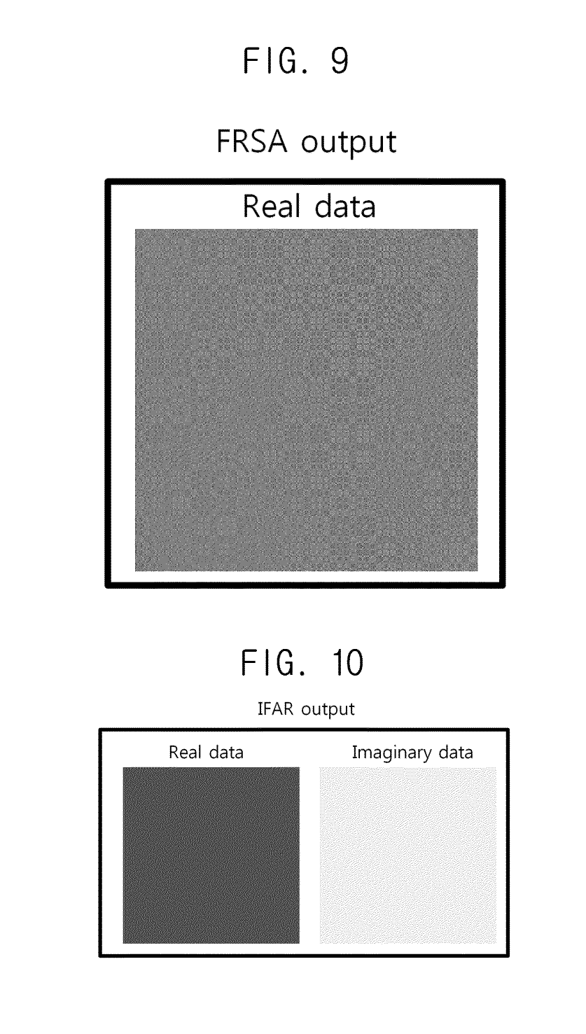

As can be seen from Equation 12, hologram data generated in the FRSA technique is real data. That is, when the FRSA technique is used, a hologram fringe pattern including real data is generated as shown in FIG. 9.

On the other hand, the IFAR technique inversely uses a Fresnel Approximation-based hologram reconstructing algorithm.

The holographic fringe pattern generated in the IFAR technique may be expressed by Equation 13 presented below, and an image generated by a Fresnel Approximation Reconstruction (FAR) technique which is the base of the IFAR may be expressed by Equation 14 presented below:

$$\begin{matrix}h = {[ Γ ( m , n ) ]}^{- 1} = \{ \frac{i}{λ d} exp ( - i \frac{2 π}{λ} d ) exp [ - i π λ d ( \frac{{m}^{2}}{{M}^{2} Δ {x}^{2}} + \frac{{n}^{2}}{{N}^{2} Δ {y}^{2}} ) ] FFT {\{ Γ ( k Δ x , I Δ y ) E ( k Δ x , I Δ y ) exp [ - i \frac{π}{λ d} ( {k}^{2} Δ {x}^{2} + {l}^{2} Δ {y}^{2} ] \} \}}^{- 1} & Equation 13 \\ I = \frac{i}{λ d} exp ( - i \frac{2 π}{λ} d ) exp [ - i π λ d ( \frac{{m}^{2}}{{M}^{2} Δ {x}^{2}} + \frac{{n}^{2}}{{N}^{2} Δ {y}^{2}} ) ] FFT \{ Γ ( k Δ x , I Δ y ) E ( k Δ x , I Δ y ) exp [ - i \frac{π}{λ d} ( {k}^{2} Δ {x}^{2} + {l}^{2} Δ {y}^{2} ) ] \} & Equation 14\end{matrix}$$

where k=2π/λ, (m,n) and (x,y) are coordinates of a holographic fringe pattern and an image, respectively, and λ is a wavelength. d is a distance between an image point and a fringe pattern point.

As can be seen from Equations 13 and 14, hologram data generated in the IFAR technique is complex data which includes imaginary data in addition to real data. That is, when the IFAR technique is used, a hologram fringe pattern including complex data which includes real data and imaginary data is generated.

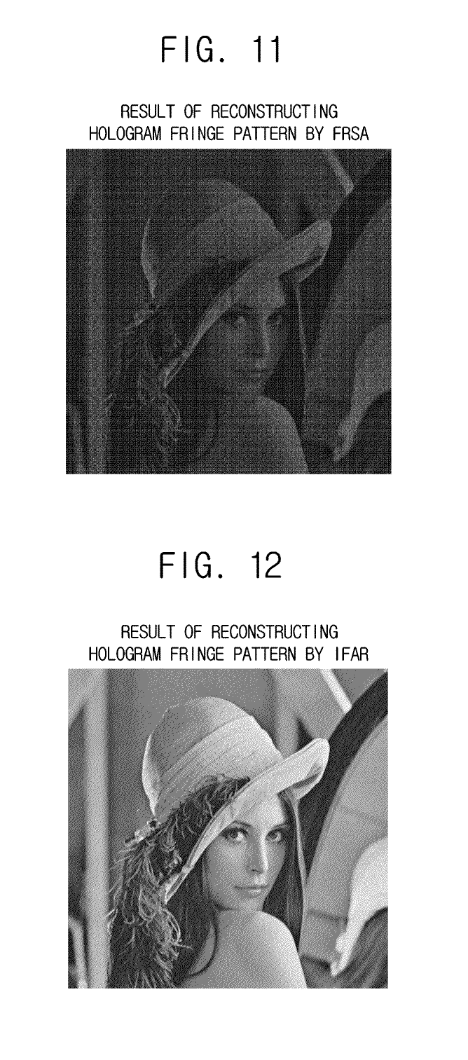

The hologram which is generated by reconstructing the hologram fringe pattern by the hologram reconstructing unit 220 is illustrated in FIGS. 11 and 12.

Specifically, FIG. 11 illustrates a result of reconstructing the hologram fringe pattern generated in the FRS technique as shown in FIG. 9, and FIG. 12 illustrates a result of reconstructing the hologram fringe pattern generated in the IFAR technique as shown in FIG. 10.

As can be seen from FIGS. 11 and 12, the hologram fringe data including the complex data (FIG. 10) has a greater sense of reality than that of the hologram fringe pattern including only the real data (FIG. 9).

Accordingly, the image-hologram conversion unit 210 converts a 2D image into a hologram using the IFAR technique first, and, when the IFAR is impossible or is not suitable, converts the 2D image into the hologram using the FRSA technique.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for generating a digital hologram, the method comprising:
clustering points of a 3D object to a plurality of clusters according to a distance to a screen;
generating diffraction patterns in a unit of a cluster; and
generating a fringe pattern by overlapping the diffraction patterns with one another.

2. The method of claim 1, wherein a distance range of points comprised in a same cluster to the screen is adjustable.

3. The method of claim 2, wherein the distance range is determined on the basis of calculation complexity.

4. The method of claim 1, wherein the generating the diffraction patterns comprises generating the diffraction patterns simultaneously by calculating in parallel for the respective clusters.

5. The method of claim 1, wherein the generating the diffraction patterns comprises generating the diffraction patterns using an RS diffraction equation which is approximated through Taylor series approximation.

6. The method of claim 5, wherein the approximation is approximating a distance between an 3D object point and a fringe pattern point using a first term of Taylor series expansion in the RS diffraction equation.

7. The method of claim 6, wherein a focal distance of a digital hologram in the RS diffraction equation is adjusted by a symmetric kernel function regarding the distance to the screen.

8. An apparatus for generating a digital hologram, the apparatus comprising:
a clustering unit configured to cluster points of a 3D object to a plurality of clusters according to a distance to a screen;
a diffraction pattern generation unit configured to generate diffraction patterns in a unit of a cluster; and
a fringe pattern generation unit configured to generate a fringe pattern by overlapping the diffraction patterns with one another.

9. The apparatus of claim 8, wherein a distance range of points comprised in a same cluster to the screen is adjustable.

10. The apparatus of claim 9, wherein the distance range is determined on the basis of calculation complexity.

11. The apparatus of claim 8, wherein the diffraction pattern generation unit is configured to generate the diffraction patterns simultaneously by calculating in parallel for the respective clusters.

12. The apparatus of claim 8, wherein the diffraction pattern generation unit is configured to generate the diffraction patterns using an RS diffraction equation which is approximated through Taylor series approximation.

13. The apparatus of claim 12, wherein the approximation is approximating a distance between an 3D object point and a fringe pattern point using a first term of Taylor series expansion in the RS diffraction equation.

14. The apparatus of claim 13, wherein a focal distance of a digital hologram in the RS diffraction equation is adjusted by a symmetric kernel function regarding the distance to the screen.

15. A method for converting into a hologram, the method comprising:
a first generation step for generating a hologram fringe pattern from an image; and
a second generation step for generating a hologram by reconstructing the hologram fringe pattern.

16. The method of claim 15, wherein the first generation step comprises a step for generating the hologram fringe pattern using one of a first technique for generating a hologram fringe pattern comprising real data from the image, and a second technique for generating a hologram fringe pattern comprising complex data from the image.

17. The method of claim 16, wherein the first generation step selectively uses one of the first technique and the second technique on the basis of an attribute of the image.

18. The method of claim 16, wherein the first technique is based on a Rayleigh-Sommerfelds Approximation-based algorithm, and
wherein the second technique is based on a Fresnel Approximation-based algorithm.

19. The method of claim 16, wherein the second technique inversely uses a Fresnel Approximation Reconstruction (FAR)-based hologram reconstructing algorithm.
